(19) United States
(12) Patent Application Publication
(10) Pub. No.: US 2007/0279943 A1
(43) Pub. Date: Dec. 6, 2007

(54) BACKLIGHT ASSEMBLY, LIQUID CRYSTAL DISPLAY APPARATUS HAVING THE SAME AND METHOD THEREOF

(75) Inventors: Yong-Woo LEE, Suwon-si (KR); Dong-Jin SEO, Cheonan-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/757,536

(22) Filed: Jun. 4, 2007

(30) Foreign Application Priority Data
Jun. 5, 2006 (KR) 1020060050153

(51) Int. Cl. F21V 7/04

(52) U.S. Cl. 362/632

(57) ABSTRACT

In a backlight assembly and an LCD apparatus including the same, a backlight assembly includes a lamp unit, a light guide plate and a receiving container. The lamp unit includes a lamp, a porosity lamp holder having a plurality of pores, and a lamp cover combined with the porosity lamp holder and surrounding the lamp. The light guide plate guides the light of the lamp unit. The receiving container receives the lamp unit and the light guide plate. The porosity lamp holder includes a porosity portion including the pores and a surface portion surrounding the porosity portion. A diameter size of the pores is between about 10 μm to about 50 μm.

This application claims priority to Korean Patent Application No. 2006-50153 filed on Jun. 5, 2006, and all the benefits accruing therefrom under 35 U.S.C. §119, the contents of which are herein incorporated by reference in its entirety.

### BACKGROUND OF THE INVENTION

1. Field of the Invention

The present invention relates to a backlight assembly and a liquid crystal display apparatus having the backlight assembly. More particularly, the present invention relates to a backlight assembly capable of preventing liquid crystal from deteriorating by heat and improving display quality, and a liquid crystal display apparatus having the backlight assembly.

2. Description of the Related Art

A liquid crystal display (“LCD”) apparatus displays images by using liquid crystal having optical and electrical characteristics such as anisotropic refraction and anisotropic dielectric constant. The LCD apparatus has various characteristics such as thinner thickness, lighter weight, lower driving voltage, lower power consumption, etc., than other display apparatuses such as cathode-ray tube (“CRT”) and plasma display panel (“PDP”). Thus, the LCD apparatus has been used in various industrial fields.

The LCD apparatus is a non-emissive type display device so that the LCD panel does not emit light by itself. The LCD apparatus requires a backlight assembly providing light.

The backlight assembly includes a lamp unit, a light guide plate and so on. The lamp unit includes a lamp emitting light, a lamp holder fixing end portions of the lamp and a lamp cover protecting the lamp. The light guide plate guides light toward the LCD panel.

However, when the lamp is operating, heat is generated by the lamp, and liquid crystal in the LCD panel is deteriorated by heat of the lamp. Thereby, display quality is also deteriorated.

### BRIEF SUMMARY OF THE INVENTION

An exemplary embodiment provides a backlight assembly configured to reduce thermal conductivity from a lamp to an LCD panel and improve display quality.

An exemplary embodiment also provides an LCD apparatus having the backlight assembly.

In an exemplary embodiment, a backlight assembly includes a lamp unit, a light guide plate and a receiving container. The lamp unit includes a lamp generating light, a lamp holder combined with end portions of the lamp and having a plurality of pores, and a lamp cover combined with the lamp holder and surrounding the lamp. The light guide plate is disposed at an opened side of the lamp cover and guides the light of the lamp unit. The receiving container receives the lamp unit and the light guide plate.

In an exemplary embodiment, a diameter size of the pores is between about 10 microns (μm) to about 50 microns (μm). The pores may be formed by injection of supercritical gas and fluid through an injection molding process.

In an exemplary embodiment, the lamp holder includes a silicone material. A porosity of the lamp holder is between about 10% and about 50%. An effective thermal conductivity of the lamp holder is between about 0.700 watt per meter per Kelvin (W/mK) to about 1.505 watts per meter per Kelvin (W/mK).

In an exemplary embodiment, the lamp holder includes a porosity portion including the pores and a surface portion surrounding the porosity portion.

In an exemplary embodiment, the lamp holder includes a lamp inserting hole into which the lamp is inserted and a wire exiting hole through which a lamp wire exits. The lamp wire is electrically connected to a lead line of the lamp.

In an exemplary embodiment, the lamp holder includes a fixing protrusion configured to be combined with the lamp cover and the lamp cover includes a fixing hole corresponding to the fixing protrusion.

In an exemplary embodiment, a liquid crystal display apparatus includes a backlight assembly providing light and a liquid crystal display panel disposed on the backlight assembly and displaying images using the light of the backlight assembly. The backlight assembly includes a lamp unit, a light guide plate and a receiving container. The lamp unit includes a lamp generating light and a lamp holder. The lamp holder is combined with end portions of the lamp and has a plurality of pores with a diameter between about 10 microns (μm) to about 50 microns (μm). The light guide plate guides the light of the lamp unit toward the liquid crystal display panel. The receiving container receives the lamp unit and the light guide plate.

An exemplary embodiment of a method of forming a backlight assembly includes forming a lamp unit including a lamp, a lamp holder including a plurality of pores, and a lamp cover, combining the lamp holder to end portions of the lamp, combining the lamp cover with the lamp holder, the lamp cover surrounding the lamp, disposing the lamp unit at opposing sides of a light guide plate, the light guide plate being disposed adjacent to an opened portion of the lamp cover; and receiving the lamp unit and the light guide plate into a receiving container.

In an exemplary embodiment, the forming a lamp unit includes forming a porosity portion and a surface portion surrounding the porosity portion of the lamp holder. A porosity of the porosity portion is between about 20% and about 30%.

In an exemplary embodiment of the backlight assembly and the liquid crystal display apparatus having the backlight assembly, heat transferred from the lamp to the LCD panel is reduced, so that the deterioration of the liquid crystal and display quality are reduced or effectively prevented.

### BRIEF DESCRIPTION OF THE DRAWINGS

The above and other advantages of the present invention will become readily apparent by reference to the following detailed description when considered in conjunction with the accompanying drawings wherein:

FIG. 1 is an exploded perspective view illustrating an exemplary embodiment of a LCD apparatus in accordance with the present invention;

FIG. 2 is a cross-sectional view illustrating the LCD apparatus in FIG. 1;

FIG. 3 is a perspective view illustrating an exemplary embodiment of a lamp unit in FIG. 1;

FIG. 4 is a perspective view illustrating a lamp holder of the lamp unit in FIG. 3;

FIG. 5 is a cross-sectional view illustrating the lamp holder in FIG. 4;

FIG. 6 is an enlarged cross-sectional view illustrating portion ‘A’ in FIG. 5;

FIG. 7 is a graph illustrating an exemplary embodiment of an effective thermal conductivity according to a porosity of the lamp holder in accordance with the present invention; and

FIGS. 8A and 8B are images illustrating exemplary embodiments of temperatures of an LCD panel in accordance with the present invention.

### DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower,” “under,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “lower” other elements or features would then be oriented “above” the other elements or features. Thus, the exemplary term “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be explained in detail with reference to the accompanying drawings.

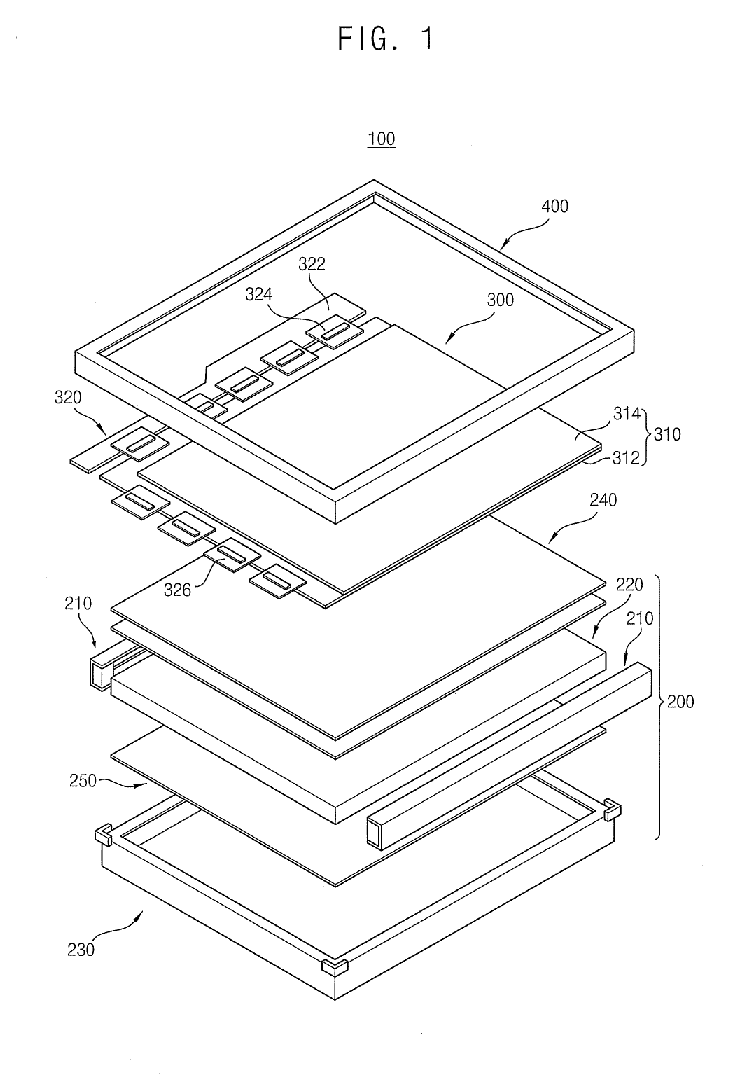

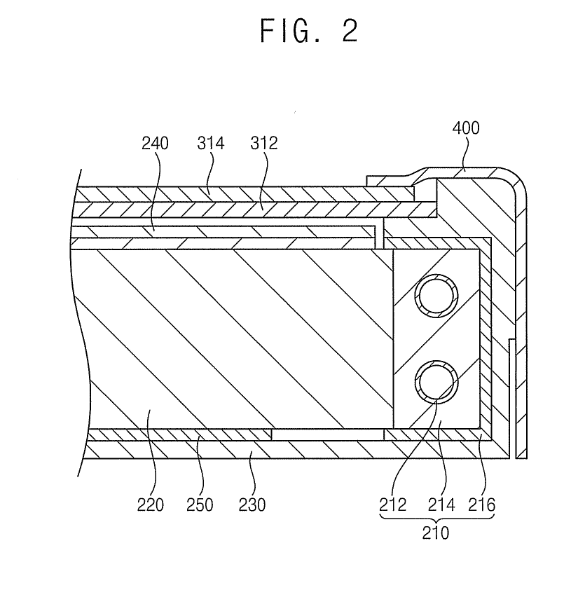

FIG. 1 is an exploded perspective view illustrating an exemplary embodiment of an LCD apparatus in accordance with the present invention. FIG. 2 is a cross-sectional view illustrating the LCD apparatus in FIG. 1.

Referring to FIGS. 1 and 2, an LCD apparatus 100 includes a backlight assembly 200 providing light, a display unit 300 and a top chassis 400 fixing the display unit 300 to the backlight assembly 200. The display unit 300 displays images using the light provided from the backlight assembly 200.

The backlight assembly 200 includes a lamp unit 210, a light guide plate 220 and a receiving container 230.

The lamp units 210 are disposed at a side of the light guide plate 220, such as adjacent to opposing sides of the light guide plate 220, and facing each other. The lamp units 210 may be disposed at opposing sides of the light guide plate 220 corresponding to longitudinal sides of the light guide plate 220. In an alternative embodiment, the lamp unit 210 may be disposed at a single side of the light guide plate 220, such as at a longitudinal side or a transverse side as required by the LCD apparatus 100.

The lamp unit 210 includes a lamp 212 emitting light, a lamp holder 214 and a lamp cover 216. The lamp holder 214 includes a plurality of porosities. The lamp holder 214 is combined with an end portion of the lamp 212. The lamp cover 216 is combined with the lamp holder 214 to surround the lamp 212. As in the illustrated embodiment, the lamp cover 216 surrounds the lamp 212 on the top, bottom and outer side (e.g., relative to the top chassis 400), and a side proximate to the light guide plate 220 is not covered or surrounded by the lamp cover 216. The lamp cover 216 may be considered to have a “C” shape when viewed in a cross section. A plurality of pores is formed inside of the lamp holder 214 to reduce an effective thermal conductivity.

As illustrated in FIG. 2, two lamps 212 are disposed inside of the lamp cover 216. Alternatively, more or less than two lamps 212, such as one or three lamps 212, may be disposed inside of the lamp cover 216.

The light guide plate 220 is disposed on an opened side of the lamp cover 216. The light guide plate 220 guides the light generated from the lamp unit 210 disposed at a side of the light guide plate 220 in a substantially normal direction to an LCD panel 310. The light guide plate 220 includes a transparent material to guide light. In one exemplary embodiment, the light guide plate 220 may include polymethyl methacrylate (“PMMA”) or polycarbonate (“PC”).

A reflective pattern (not shown) may be formed under (e.g., on a lower surface of) the light guide plate 220 to diffuse and to reflect the light. In one exemplary embodiment, the reflective pattern may be formed by a printed pattern or embossing pattern. An incident light from the lamp unit 210 to an inside of the light guide plate 220 is diffused and reflected by the reflective pattern. A light over a critical angle with respect to a normal direction of a front (e.g., upper) surface of the light guide plate 220 exits from the light guide plate 220 through the front surface (e.g., emitting surface) of the light guide plate 220.

Referring again to FIGS. 1 and 2, the receiving container 230 receives a lamp unit 210 and the light guide plate 220. In an exemplary embodiment, the receiving container 230 may include synthetic resin, and/or may be manufactured using an injection molding method. A bottom plate of the receiving container 230 may include an opening at a center of the bottom plate to reduce a weight of the backlight assembly 200, thereby contributing to a lower weight of the overall LCD apparatus 100, and to improve heat radiation efficiency.

The backlight assembly 200 may further include at least one optical sheet 240 and a reflective plate 250. The optical sheet 240 may be disposed on the light guide plate 220, e.g., facing the upper surface of the light guide plate 220, and the reflective plate 250 may be disposed under the light guide plate 220, e.g., facing the lower surface of the light guide plate 220.

The optical sheet 240 improves front brightness of the light exiting from the light guide plate 220 in the normal direction of the LCD panel 310. In exemplary embodiments, the optical sheet 240 may include a diffusion sheet that diffuses the light exiting from the light guide plate 220 to improve brightness uniformity.

Moreover, the optical sheet 240 may include a prism sheet that condenses the light exiting from the light guide plate 220 in a front direction and improves front brightness of the light.

In addition, the optical sheet 240 may include a reflection polarizing sheet that transmits light satisfying a required condition and reflects light unsatisfying the required condition. In one exemplary embodiment, the reflection polarizing sheet may transmit a portion of the light vibrating in a longitudinal direction of the reflection polarizing sheet, and may reflect a remaining portion of the light.

The backlight assembly 200 may include various functional sheets according to required brightness characteristics.

The reflective plate 250 reflects a leaking light to under the light guide plate 220 to improve light efficiency. The reflective plate 250 may include a high reflective material. In one exemplary embodiment, the reflective plate 250 may include white polyethylene terephthalate (“PET”) or polycarbonate (“PC”) material. The reflective plate 250 may be formed as a metallic plate such as a white reflective sheet laminated on an aluminum (Al) plate.

The reflective plate 250 is disposed under the light guide plate 220 to cover the opening in the bottom plate of the receiving container 230. The reflective plate 250 reduces or effectively prevents inflowing of impurities into the inside of the receiving container 230 through the opening of the bottom plate of the receiving container 230.

The display unit 300 includes the LCD panel 310 and a driving circuit part 320. The LCD panel 310 displays images using the light provided from the backlight assembly 200, and the driving circuit part 320 drives the LCD panel 310.

The LCD panel 310 is mounted on the receiving container 230 to be disposed on the optical sheet 240. The LCD panel 310 includes a lower substrate 312, an upper substrate 314 facing the lower substrate 312 and a liquid crystal layer (not shown) disposed between the upper substrate 314 and the lower substrate 312.

The lower substrate 312 includes a thin film transistor (“TFT”) (not shown) that functions as a switching device. Alternatively, the lower substrate 312 may include a plurality of TFTs (not shown) formed as a matrix shape. In one exemplary embodiment, the lower substrate 312 may include a transparent glass material allowing transmission of light. A source terminal and a gate terminal of each of the TFTs are electrically connected to a data line and a gate line, respectively, and a drain terminal of the TFT is electrically connected to a pixel electrode including a transparent conductive material.

The upper substrate 314 includes a color filter substrate having red, green and blue color filters to display color images. In one exemplary embodiment, the upper substrate 314 may include a transparent glass material. A common electrode including a transparent conductive material is formed on the upper substrate 314. Alternatively, the color filter may be formed on the lower substrate 312.

When an electric power is applied to the gate terminal of the TFT to turn-on the TFT, an electric field is formed between the pixel electrode and the common electrode of the LCD panel 310. An arrangement of liquid crystal molecules of the liquid crystal layer disposed between the lower substrate 312 and the upper substrate 314 is changed by the electric field, and a transmittance rate of the light provided from the backlight assembly 200 is changed according to the change of the arrangement of the liquid crystal molecules, so that images having a required grayscale are displayed.

Referring again to FIG. 1, the driving circuit part 320 includes a source printed circuit board 322, a data driving circuit film 324 and a gate driving circuit film 326. The source printed circuit board 322 outputs a control signal for driving the LCD panel 310, and the data driving circuit film 324 electrically connects the source printed circuit board 322 to the LCD panel 310. The gate driving circuit film 326 is electrically connected to the LCD panel 310.

The data driving circuit film 324 is electrically connected to the data line of the lower substrate 312, and the gate driving circuit film 326 is electrically connected to the gate line of the lower substrate 312.

The data driving circuit film 324 and the gate driving circuit film 326 may include a driving chip outputting a driving signal for driving the LCD panel 310 based on the control signal provided from the source printed circuit board 322. In an exemplary embodiment, the data driving circuit film 324 and/or the gate driving circuit film 326 may include a tape carrier package (“TCP”) or a chip on film (“COF”).

The driving circuit part 320 may further include a gate printed circuit board (not shown) electrically connected to the gate driving circuit film 326.

The top chassis 400 is combined with the receiving container 230 to fix corners and peripheral edges of the LCD panel 310 to the backlight assembly 200. The source printed circuit board 322 may be disposed on a rear surface of the receiving container 230 when the data driving circuit film 324 is bent towards the receiving container 230. The top chassis 400 may include a metallic material having low deformation and high strength characteristics.

The top chassis 400 is combined with the receiving container 230 so that the LCD panel 310, the receiving container 230 and the lamp unit 210 adhere to each other, and a portion of the receiving container 230 is disposed between the LCD panel 310 and the lamp unit 210, such as proximate to end portions of the lamps 212. Advantageously, heat generated at the end portions of the lamp 212 may be transferred toward the LCD panel 310 through the lamp holder 214, the lamp cover 216 and the receiving container 230. The pores formed inside of the lamp holder 214 may reduce thermal conductivity and effectively “hold” an increased temperature of the LCD panel 310.

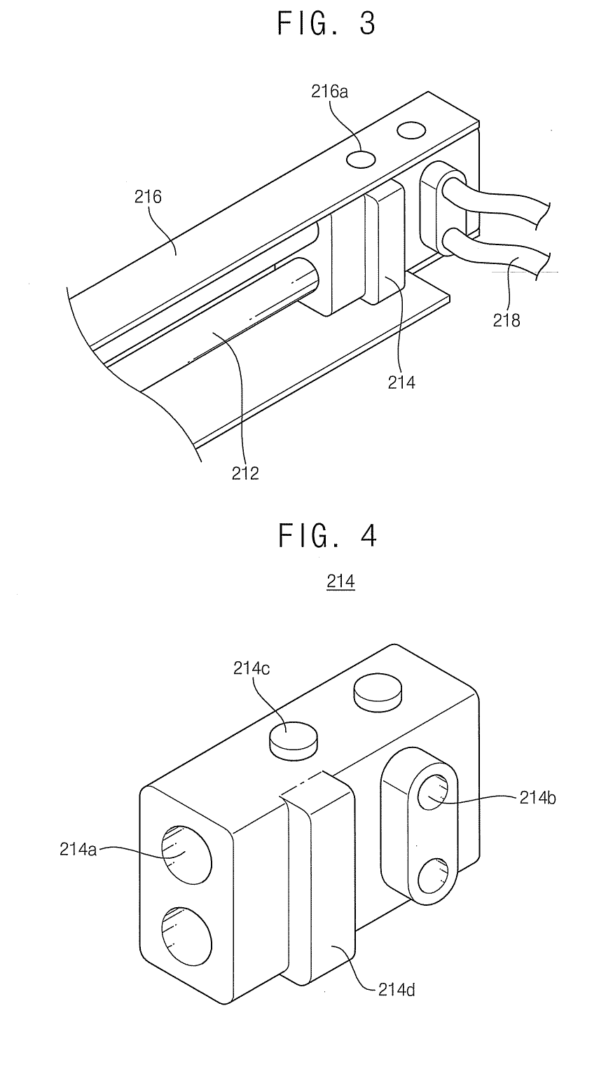

FIG. 3 is a perspective view illustrating an exemplary embodiment of a lamp unit in FIG. 1. FIG. 4 is a perspective view illustrating a lamp holder of the lamp unit in FIG. 3.

Referring to FIGS. 3 and 4, a lamp unit 210 includes a lamp 212 emitting light, a lamp holder 214 and a lamp cover 216. The lamp holder 214 includes a plurality of porosities. Alternatively, the lamp unit 210 may include a plurality of lamps 212. The lamp holder 214 fixes end portions of the lamp 212, and the lamp cover 216 covers portions of the lamp 212.

The lamp 212 generates light based on a driving power applied by an external device (not shown). In one exemplary embodiment, the lamp 212 may include a cold cathode fluorescent lamp (“CCFL”) having a substantially cylinder shape.

The lamp holder 214 includes a lamp inserting hole 214a and a wire exiting hole 214b.

The lamp inserting hole 214a is formed at one side of the lamp holder 214. The number of the inserting holes 214a may be substantially the same as the number of the lamps 212. The lamp inserting hole 214a has substantially a same diameter as an outside diameter of the lamp 212 to securely hold the inserted lamp 212.

A lead line (not shown) formed at the end portion of the lamp 212 is electrically connected to a lamp wire 218 in the lamp holder 214. In an exemplary embodiment, the lead line (not shown) may be electrically connected to the lamp wire 218 by a soldering method. The lamp wire 218 electrically connected to the lead line of the lamp 212 exits the lamp holder 214 through the wire exiting hole 214b.

The lamp holder 214 may further include a fixing protrusion 214c to combine the lamp holder 214 with the lamp cover 216. In an exemplary embodiment, the fixing protrusion 214c may be formed at a top surface and/or a bottom surface of the lamp holder 214. In the illustrated embodiment, two fixing protrusions

The lamp holder 214 may guides a receiving position of the light guide plate 220. The lamp holder 214 may further include a stopper 214d. The stopper 214d reduced or effectively prevents sliding or movement of the light guide plate 220 toward the lamp 212.

The lamp cover 216 is combined with the lamp holder 214, and surrounds the lamp 212. In an exemplary embodiment, the lamp cover 216 may include a metallic material having high reflectivity or may be formed by coating a reflective material having relatively high reflectivity on a surface of a metal plate. The lamp cover 216 reflects the light emitted from the lamp 212 toward the light guide plate 220, so that an efficiency of the light improves.

Referring to FIG. 4, the lamp cover 216 includes a fixing hole 216a corresponding to the fixing protrusion 214c such that the lamp cover 216 is configured to be combined with the lamp holder 214. By combination of the fixing protrusion 214c with the fixing hole 216a, the lamp holder 214 is fixed stably at the lamp cover 216. As used herein, the fixing hole 216a may be considered as “corresponding” to the fixing protrusion 214c substantially in shape, size and/or positional placement.

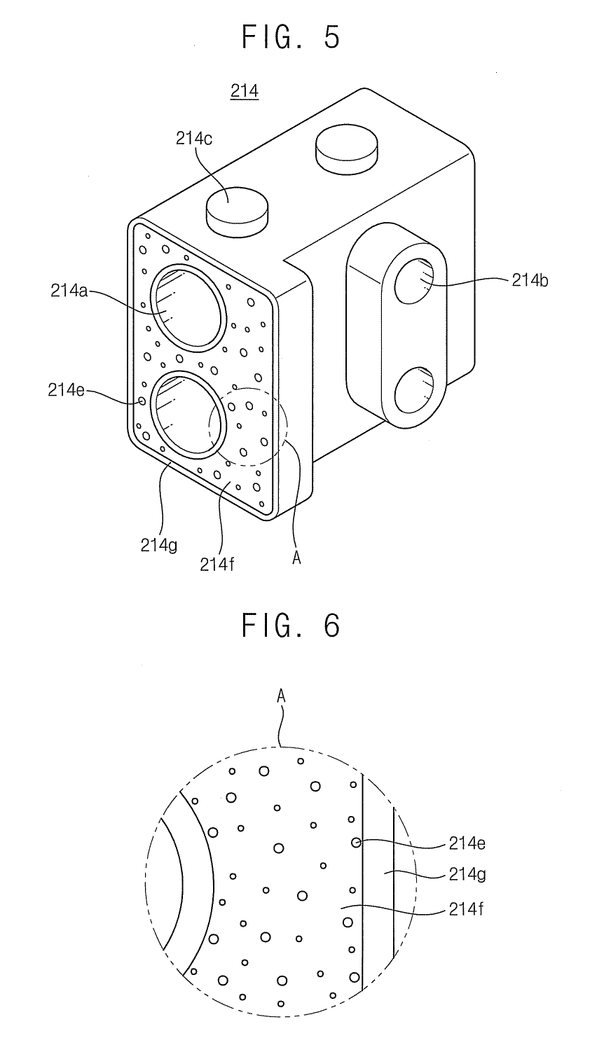

FIG. 5 is a cross-sectional view illustrating the lamp holder in FIG. 4. FIG. 6 is an enlarged cross-sectional view illustrating portion ‘A’ in FIG. 5.

Referring to FIGS. 5 and 6, the lamp holder 214 includes a plurality of pores 214e to reduce thermal conductivity.

The lamp holder 214 includes a porosity portion 214f including pores 214e and a surface portion 214g surrounding the porosity portion 214f. The porosity portion 214f completely surrounds the lamp inserting holes 214a, such that the lamp inserting holes 214a are spaced apart from the surface portion 214g at a predetermined distance on sides of the lamp inserting holes 214a.

The pores 214e formed in the porosity portion 214f have a diameter size between about 10 microns (μm) to about 50 microns (μm), thereby maintaining the required rigidity and compressibility of the lamp holder 214. When the diameter of each of the pores 214e is over about 50 μm, rigidity and compressibility of the lamp holder 214 are deteriorated and/or an assembling of the lamp holder 214 may be deteriorated.

The pores 214e are not formed in the surface portion 214g. The surface portion 214g has a thickness taken in a direction from an outer surface of the lamp holder 214 toward the porosity portion 214f. The thickness of the surface portion 214g may be substantially uniform, but the invention is not limited thereto. The surface portion 214g does not include the pores 214e, such that the lamp holder 214 is resistant against deformation from an external force to the lamp holder 214.

In an exemplary embodiment, the lamp holder 214 may be formed by injecting a supercritical gas and/or a fluid during an injection molding process. When the lamp holder 214 is formed in an injection molding process, the supercritical gas is supplied therewith and the lamp holder 214 with the supercritical gas is cooled. The injected gas is expended or removed and the pores 214e are formed. In one exemplary embodiment, the gas used in the injection molding process of the lamp holder 214 may include, but is not limited to, nitrogen (N₂) or carbon dioxide (CO₂) which is inactive gas.

An effective thermal conductivity (“KefF”) of the lamp holder 214 is changed or effected by a porosity of the lamp holder 214. The porosity is defined as a volume ratio of the pores 214e to an entire volume of the lamp holder 214.

An effective thermal conductivity (“Keff”) of the porosity material is obtained by Jakob's equation presented by the following equation 1.

$${K}_{eff} = {K}_{S} [ 1 + \frac{3 ɛ ( 1 - {K}_{S} / {K}_{f} )}{( 1 - ɛ ) + ( 2 + ɛ ) {K}_{S} / {K}_{f}} ] \qquad Equation 1$$

In Equation 1, Kₛ is a thermal conductivity of a medium, K_{f} is a thermal conductivity of the gas in the pores, and ε is a porosity.

In an exemplary embodiment, the lamp holder 214 may include silicone material. The thermal conductivity of the silicone material is about 1.75 watts per meter per Kelvin (W/mK). Moreover, the nitrogen or carbon dioxide in the pores 214e has a thermal conductivity close to zero, which is about 10⁻⁴ watt per meter per Kelvin (W/mK).

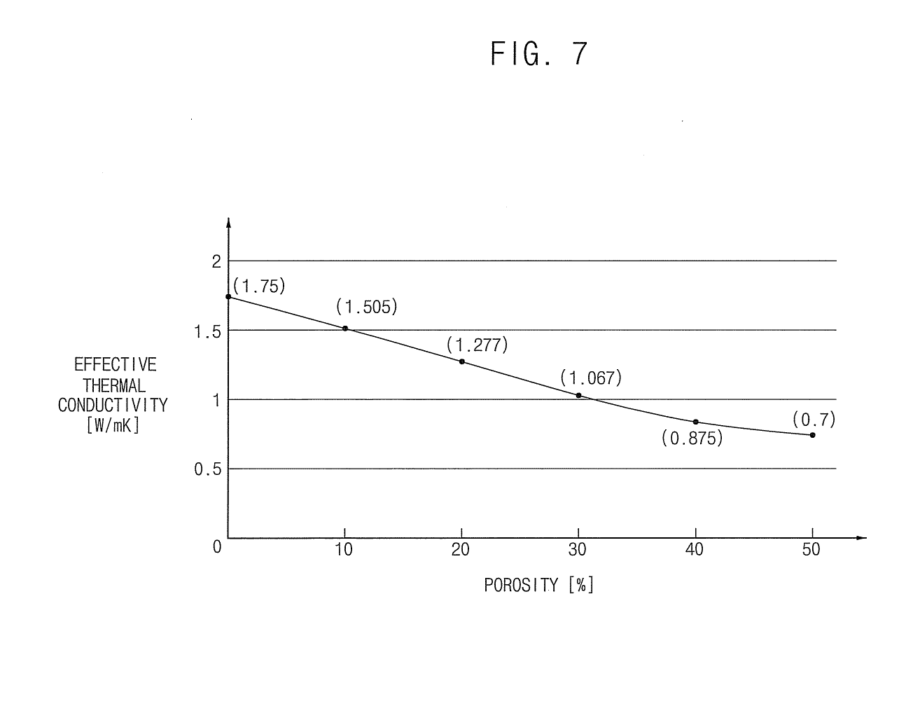

FIG. 7 is a graph illustrating an exemplary embodiment of an effective thermal conductivity according to a porosity of the lamp holder in accordance with the present invention. In FIG. 7, the effective thermal conductivity of the lamp holder is obtained by equation (1).

Referring to FIG. 7, the effective thermal conductivity of the lamp holder including silicone material is decreased as the porosity is increased.

When the pores are not formed, a thermal conductivity of the lamp holder 214 may be about 1.75 W/mK. However, when the porosity is about 10%, 20%, 30%, 40% and 50%, the thermal conductivity is about 1.505, 1.277, 1.067, 0.875 and 0.7 W/mK, respectively. As illustrated in FIG. 7, when the porosity is about 50%, the effective thermal conductivity is reduced to about 40% of a thermal conductivity of 2 W/mK compared with the effective thermal conductivity when the porosity is zero.

The effective thermal conductivity of the lamp holder 214 is decreased as the porosity of the lamp holder 214 is increased. However, when the porosity is increased too much, rigidity and compressibility of the lamp holder 214 may be deteriorated. In exemplary embodiments, the lamp holder 214 may have the porosity between about 10% to about 50%, such that the lamp holder 214 may reduce the effective thermal conductivity, but maintain enough rigidity and compressibility. In one exemplary embodiment, the lamp holder 214 may have the porosity between about 20% to 30%.

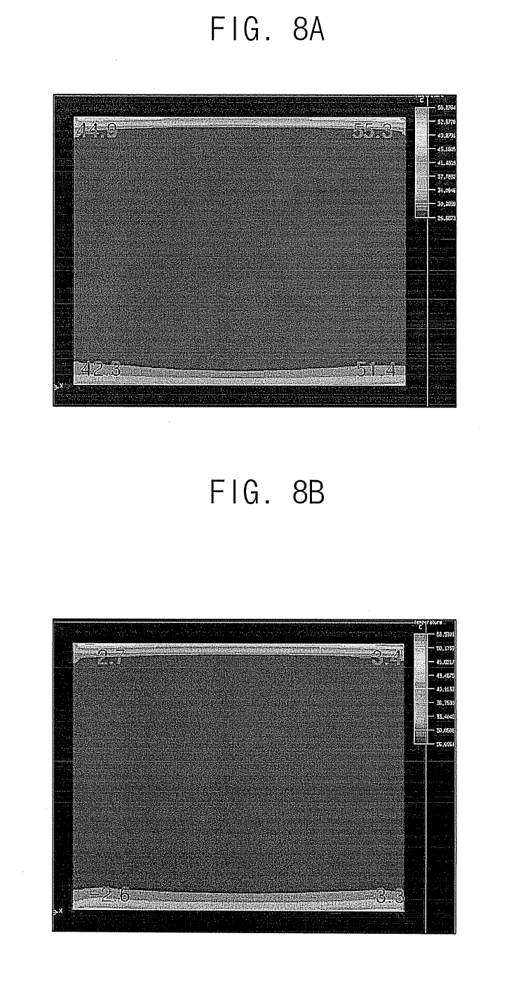

FIGS. 8A and 8B are images illustrating exemplary embodiments of temperatures of an LCD panel in accordance with the present invention. FIG. 8A illustrates temperature of the LCD panel when pores are not formed in the lamp holder and the thermal conductivity of the lamp holder is about 1.75 W/mK. FIG. 8B illustrates temperature of the LCD panel when the porosity of the lamp holder is about 40% and the thermal conductivity of the lamp holder is about 0.875 W/mK.

Referring to FIGS. 8A and 8B, when the porosity of the lamp holder 214 is about 40%, temperature of the LCD panel is reduced at least about 2.6° C. when compared with the LCD panel temperature when the pore is not formed.

In the illustrated embodiments of the backlight assembly and the LCD apparatus having the backlight assembly, heat transferred from the lamp to the LCD panel is reduced using the lamp holder having the pores inside of the lamp holder, such that the deterioration of the liquid crystal and display quality are reduced or effectively prevented.

In an exemplary embodiment, the lamp holder has a lower viscosity than a conventional lamp holder, so that a lower pressure may be used in the injection molding process and the surface tension is reduced.

In addition, since the lamp holder has the relatively low viscosity and uses the relatively low injection pressure, precision of the manufacturing process may be increased such that a minute structure, such as small stepped portion, corner and so on may be relatively easily formed.

Those skilled in this art will appreciate that many modifications, substitutions and variations can be made in and to the materials, apparatus, configurations and methods of the display panels of the present invention without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalents.

What is claimed is:

1. A backlight assembly comprising:
a lamp unit including:
a lamp generating light;
a lamp holder combined with end portions of the lamp and comprising a plurality of pores; and
a lamp cover combined with the lamp holder and surrounding the lamp;
a light guide plate disposed at an opened side of the lamp cover and guiding the light of the lamp unit; and
a receiving container receiving the lamp unit and the light guide plate.

2. The backlight assembly of claim 1, wherein a diameter size of the pores is between about 10 microns (μm) to about 50 microns (μm).

3. The backlight assembly of claim 2, wherein the pores are formed by injection of supercritical gas and fluid through an injection molding process.

4. The backlight assembly of claim 2, wherein a porosity of the lamp holder is between about 10% to about 50%.

5. The backlight assembly of claim 4, wherein the lamp holder comprises a silicone material.

6. The backlight assembly of claim 5, wherein an effective thermal conductivity of the lamp holder is between about 0.700 watt per meter per Kelvin (W/mK) and about 1.505 watts per meter per Kelvin (W/mK).

7. The backlight assembly of claim 6, wherein the lamp holder further comprises:
a porosity portion including the pores; and
a surface portion surrounding the porosity portion.

8. The backlight assembly of claim 3, wherein the lamp holder further comprises:
a lamp inserting hole into which the lamp is inserted; and
a wire exiting hole through which a lamp wire exits, the lamp wire being electrically connected to a lead line of the lamp.

9. The backlight assembly of claim 8, wherein the lamp holder further comprises a fixing protrusion configured to be combined with the lamp cover,
and the lamp cover comprises a fixing hole corresponding to the fixing protrusion of the lamp holder.

10. The backlight assembly of claim 3, wherein the lamp unit is disposed at opposing sides of the light guide plate.

11. The backlight assembly of claim 3, further comprising:
a reflective sheet disposed under the light guide plate; and
an optical sheet disposed on the light guide plate.

12. A liquid crystal display apparatus comprising:
a backlight assembly providing light; and
a liquid crystal display panel disposed on the backlight assembly and displaying images using the light of the backlight assembly,
wherein the backlight assembly includes:
a lamp unit comprising a lamp generating light, and a lamp holder combined with end portions of the lamp and including a plurality of pores with a diameter between about 10 microns (μm) to about 50 microns (μm),
a light guide plate guiding the light of the lamp unit toward the liquid crystal display panel; and
a receiving container receiving the lamp unit and the light guide plate.

13. The liquid crystal display apparatus of claim 12, wherein the lamp holder further includes a silicone material, and a porosity of the lamp holder is between about 20% to about 30%.

14. The liquid crystal display apparatus of claim 12, wherein the lamp holder further includes:
a lamp inserting hole into which the lamp is inserted; and
a wire exiting hole through which a lamp wire exits, the lamp wire being electrically connected to a lead line of the lamp.

15. The liquid crystal display apparatus of claim 14, wherein the liquid crystal display panel comprises:
a lower substrate including thin film transistors arranged in a matrix shape;
an upper substrate combined with the lower substrate and facing the lower substrate; and
a liquid crystal layer disposed between the lower substrate and the upper substrate.

16. The liquid crystal display apparatus of claim 15, wherein the lamp holder further includes:
a porosity portion including the pores; and
a surface portion surrounding the porosity portion.

17. A method of forming a backlight assembly for a liquid crystal display apparatus, the method comprising:
forming a lamp unit including a lamp, a lamp holder including a plurality of pores, and a lamp cover;
combining the lamp holder to end portions of the lamp;
combining the lamp cover with the lamp holder, the lamp cover surrounding the lamp;
disposing the lamp unit at opposing sides of a light guide plate, the light guide plate being disposed adjacent to an opened portion of the lamp cover; and
receiving the lamp unit and the light guide plate into a receiving container.

18. The method of claim 17, wherein the forming a lamp unit includes forming a porosity portion and a surface portion surrounding the porosity portion of the lamp holder, wherein a porosity of the porosity portion is between about 20% and about 30%.

19. The method of claim 17, wherein the forming a lamp unit includes forming the pores in the lamp holder, the forming the pores including injection of a supercritical gas or fluid in an injection molding process and expending the injected gas or fluid, thereby forming the pores in the lamp holder.
